(19) United States
(12) Patent Application Publication
(10) Pub. No.: US 2006/0188357 A1
(43) Pub. Date: Aug. 24, 2006

(54) Nut cap and method of securing a nut on a bolt

(75) Inventors: Charles M. Rowe, Titusville, FL (US); Benjamin T. Humphries, Orlando, FL (US)

Correspondence Address: Siemens Corporation;Intellectual Property Department, 170 Wood Avenue South, Iselin, NJ, 08830, US

(73) Assignee: Siemens Westinghouse Power Corp.

(21) Appl. No.: 11/062,283

(22) Filed: Feb. 18, 2005

(51) Int. Cl. F16B 39/10

(52) U.S. Cl. 411/119

(57) ABSTRACT

An apparatus for containing a nut on a bolt including a housing having a main body, a proximal end and a distal end. A threaded aperture may be formed within the distal end of the main body for threading the housing onto the bolt. A flange extending from the housing that may engage the substrate when the housing is threaded over the bolt. At least one aperture formed within the flange for securing the housing to the substrate. A pair of housings may be placed adjacent one another and secured in a stationary position by a connector inserted through respective apertures formed in a flange of each housing. The connector may connect the housings together and be sized to prevent each housing from turning beyond an acceptable tolerance with respect to the other housing. The connector may be used to secure individual housings to other stationary components.

### FIELD OF THE INVENTION

This invention relates to assemblies for covering and enclosing the exposed end of a bolt and in particular to a nut cap apparatus that prevents a nut from coming off a bolt in operating environments where nuts are susceptible to loosening from bolts.

### BACKGROUND OF THE INVENTION

A turbine power generator generates electric power by converting mechanical energy into electrical energy. Such generators typically include a stator and rotor to generate electrical power as the rotor turns within the stator. The rotor is driven by the rotation of a drive shaft that connects to and turns the rotor. The drive shaft of the turbine power generator is, in turn, driven by steam or combustion supplied within a turbine section of the turbine power generator.

In certain operating environments within a turbine power generator it is desirable to use non-metallic and non-conductive components to better withstand effects from electromagnetic fields. Such components may be used in turbine generators, including fasteners such as nuts and bolts fabricated of fiberglass or similar compositions for securing components in place. Components made of these compositions may undergo deformations because they are exposed to high operating temperatures, which may cause nuts to loosen from bolts.

A locking technique for fiberglass fasteners used in turbine generators is known that uses a piece of epoxy treated twine wrapped around the threaded bolt projecting above the nut. A disadvantage of this technique is that the epoxy resin may wick down into the threads and permanently cement the bolt and nut together. This may cause problems when the nut needs to be removed or re-tensioned such as breaking the bolt when trying to adjust the nut.

Also, if the twine is not installed with a proper amount of epoxy resin then it may separate from the bolt becoming a foreign object entering the operating environment of the generator. This may cause damage to generator components and with the epoxy thread off the bolt the likelihood the nut will loosen is increased. This may also lead to damage to generator components or lead to degradation in generator performance.

### SUMMARY OF THE INVENTION

In view of the above, it may be beneficial to ensure that fasteners, such as an internally threaded nut will not loosen on the mating, externally threaded bolt.

An apparatus or nut cap for containing a nut on a bolt extending through a substrate, the apparatus including a housing having a main body, a proximal end and a distal end. A threaded aperture may be formed within the distal end of the main body for threading the housing onto the bolt. A flange may extend from at least a portion of the housing that may engage the substrate when the housing is threaded over the bolt. At least one aperture may be formed within the flange for receiving a screw for securing the housing to the substrate. A pair of housings may be placed adjacent one another and secured in a stationary position by a connector inserted through respective apertures formed in a flange of each housing. The connector may connect the housings together and be sized to prevent each housing from turning beyond an acceptable tolerance with respect to the other housing. The connector may be used to secure individual housings to other stationary components.

### BRIEF DESCRIPTION OF THE DRAWINGS

These and other advantages of the invention will be more apparent from the following description in view of the drawings that show:

FIG. 1 is a cross sectional view of an exemplary embodiment of the invention placed over a nut and bolt.

FIG. 2 illustrates a cross sectional view of another exemplary embodiment of the invention placed over a nut and bolt.

FIG. 3 illustrates a cross sectional view of another exemplary embodiment of the invention placed over a nut and bolt.

FIG. 4 is a plan view of the exemplary embodiment of FIG. 1.

FIG. 5 a cross sectional view of a pair of exemplary embodiments of the invention of FIG. 1 in an adjacent configuration.

### DETAILED DESCRIPTION OF THE INVENTION

FIG. 1 illustrates a cross sectional view of an exemplary embodiment of a nut cap 10 that may be used for ensuring that a nut doesn't loosen from a bolt. Nut cap 10 may be used in a variety of operating environments including a combustion turbine generator that is high temperature and has a plurality of stationary components within the operating environment. Nut cap 10 may include a housing 12 comprising a main body 14, a proximal end 16 and a distal end 18. An aperture 20 may be formed within distal end 18 and may have internal threads for threading housing 12 onto a threaded portion of a bolt 22, which may extend through a substrate 24. Substrate 24 may be a substrate made of any material and in an embodiment of the invention is a substrate within a generator of a combustion turbine.

A nut 26 is threaded onto bolt 22 and a spring washer 28 may be placed between nut 26 and substrate 24. Nut 26 and bolt 22 may be fabricated from various materials suitable for use a turbine generator that typically operates within a temperature range of about 60° C. to 80° C. In an embodiment of the invention they may be fabricated from a high impact and heat resistant material such as plastic, fiberglass (NEMA grade G11 fiberglass, for example), hard rubber or similar compositions.

Housing 12 may include a flange 30 extending there from such as from at least a portion of proximal end 16. In an embodiment, flange 30 may extend from proximal end 16 and engage substrate 24 when housing 12 is threaded over a threaded portion of bolt 22. Flange 30 may include a means integral to the flange for securing the flange to a stationary component of the generator so housing 12 is maintained in a stationary position relative to the nut 26. The means for securing may include one or more apertures 32 for receiving a respective fastener, such as screws 31, for fastening housing 12 to substrate 24. Flange 30 may have at least one pair of diametrically opposed apertures 32. Fastening housing 12 to substrate 24 secures the housing in a stationary position and may prevent nut 26 from loosening. This arrangement prevents nut 26 from becoming a foreign object and falling into the operating environment of the generator if it loosens from bolt 22. Flange 30 may be multi-stepped to accommodate variations in the configuration of substrate 24 or other stationary components to which housing 12 may be attached. In alternate embodiments, the apertures may be notches in flange 30 or eyehooks extending there from, for example.

A plurality of apertures 32 may be formed within flange 30 depending on the size of housing 12 and the operating environment within which nut cap 10 will be used. For example, some operating environments may experience strong vibrations so more than one aperture 32, or other means for securing, may be needed to secure housing 12 in a stationary position such as by fastening it to substrate 24.

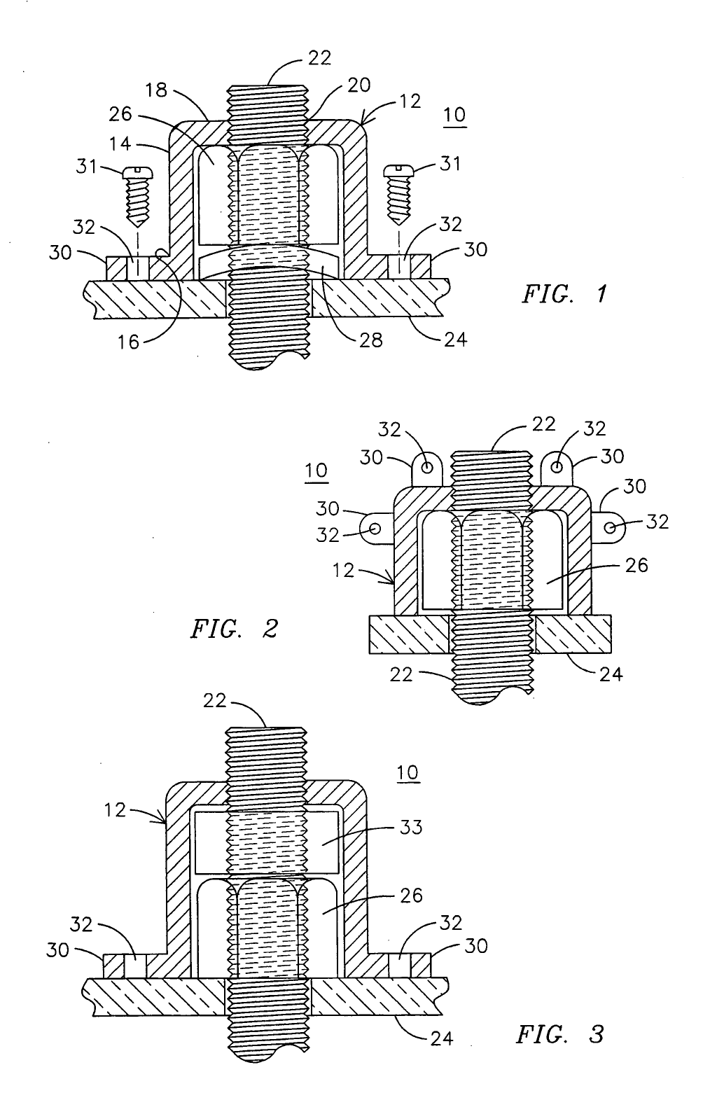

Flange 30 may be formed in various configurations and may extend partially or entirely around the circumference of proximal end 16 of housing 12. For example, flange 30 may be one or more discrete legs extending from housing 12 in spaced relation around the circumference of proximal end 16. An aperture 32 may be formed in one or more of such discrete legs. In other alternate embodiments, one or more flanges 30 may extend from distal end 18 or from along main body 14 as shown in FIG. 2. Positioning flanges 30 at these or other various locations on housing 12 allows for housing 12 to be secured in a stationary position by connecting or tying it off to one or more stationary components that may be located in different directions away from housing 12. In some situations substrate 24 may have limited space to which housing 12 may be secured so flanges 30 may need to be positioned as shown in the exemplary embodiment of FIG. 2.

Housing 12 may be formed in various shapes and sizes depending on design specifications such as the shape and/or size of nut 26 or the size and/or length of bolt 22. In an exemplary embodiment of the invention housing 12 may be substantially cylindrical having rounded outer and inner edges. An internal cavity defined by housing 12 may be sized so that when threaded aperture 20 is threaded over bolt 22 flange 30 will abut a surface of substrate 24 as shown in FIG. 1. In this respect, when housing 12 is threaded over bolt 22 the inner surface of distal end or end cap 18 of housing 12 may abut the top of nut 26 and flange 30 may abut flush against substrate 24. End cap 18 abutting the top of nut 26 may create a “double-nut” locking arrangement to ensure nut 26 doesn't loosen from bolt 22.

Fiberglass screws 31 may be used for fastening housing 12 to substrate 24 and may be secured in place within substrate 24 using an epoxy resin. One or more screws 31 may be used and tightened to secure housing 12 via flange 30 in fixed relation to substrate 24. In this manner, the inner surface of end cap 18 may abut the top of nut 26 thereby preventing nut 26 from loosening during operating conditions. Other fasteners may be used for securing housing 12 to substrate 24.

In alternate embodiments, the inner surface of end cap 18 may be slightly above the top of nut 26 to account for performance tolerances. In some operating environments housing 12 may be permitted to move or rotate slightly with respect to substrate 24 in compliance with operating tolerances. Further, the thickness of end cap 18 may vary to ensure a sufficient thread count therein to avoid stripping these threads when tightened onto the top of nut 26. The thickness of end cap 18 may vary, for example, as a function of the composition and size of bolt 22, nut 26 and housing 12, and the operating environment within which they will be used.

FIG. 3 illustrates an exemplary embodiment that may include an internally threaded insert 33 sized to fit within the internal cavity of housing 12. Insert 33 may be molded as part of housing 12 or it may be a separate component threaded over bolt 22 prior to placement of housing 12. Insert 33 may be sized to varying heights and may create a “double-nut” locking arrangement with the top of nut 26 to ensure nut 26 doesn't loosen from bolt 22. When housing 12 is threaded over bolt 22 the inner surface of end cap 18 may be above the top of insert 33 or tightened against insert 33 to create a “double-nut” locking arrangement between housing 12 and insert 33. Insert 33 may be fabricated from a high impact and heat resistant material such as plastic, fiberglass (NEMA grade G11 fiberglass, for example) or a similar composition for use within the generator of a combustion turbine.

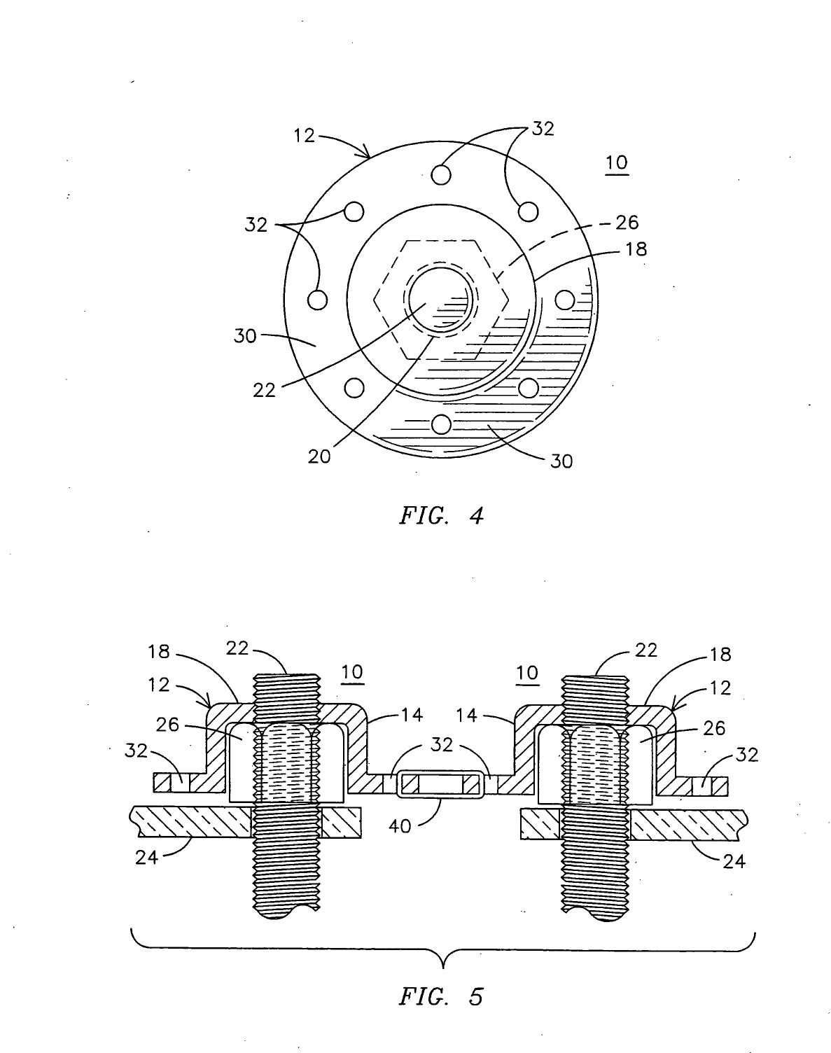

FIG. 4 is a plan view of an exemplary housing 12 threaded over nut 26. Housing 12 may include distal end or end cap 18, flange 30 and a plurality of apertures 32 formed within flange 30. Aperture 20 may be formed along a longitudinal centerline of housing 12 so it may be easily threaded over bolt 22.

Embodiments of the invention may be used in close proximity to one another to prevent one or more nuts 26 from loosening, or coming off a respective bolt 22 if a nut 26 does loosen, as shown in FIG. 5. In this respect, a first housing 12 may be secured in a stationary position with a second housing 12 using a connector 40. Connector 40 may be a fiberglass twine or cord having an exemplary diameter of between about 0.094 and 0.096 inches. This diameter may vary in other exemplary embodiments. Connector 40 may be inserter through respective apertures 32 of adjacent nut caps 10. Alternate embodiments allow for connector 40 to pass through apertures 32 and corresponding apertures (not shown) in substrate 24, or connectors 40 may tie a housing 12 to a stationary component within a generator, for example, to secure housing 12 in a stationary position. Respective ends of a connector 40 may be cemented together and/or cemented to stationary components using epoxy.

Connector 40 may be sized so to restrict turning of a nut cap 10 with respect to another adjacent nut cap 10 to maintain the respective nut caps 10 in a stationary position. Restricting the relative turning of nut caps 10 in this manner ensures that nuts 26 will remain locked on respective bolts 22. It will be recognized that connector 40 may be sized to tolerate some rotation of a nut cap 10, which may be a function of operational specifications of the environment within which embodiments of the invention are being used. Similarly, connector 40 may be sized to secure nut cap 10 in a stationary position if nut cap 10 is connected to a stationary component that may be located in various directions and distances from nut cap 10.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

1) An apparatus for securing a nut on a bolt within an operating environment comprising a plurality of stationary components, the apparatus comprising:
a housing comprising a main body, a distal end and a proximal end, the main body defining an interior cavity having a constant cross section along its longitudinal axis between the distal end and the proximal end, the housing sized to fit over and cover at least a portion of the nut so that the interior cavity is spaced away from the nut;
a threaded aperture formed within the distal end for threading the housing onto a threaded portion of the bolt, the threaded aperture forming a through hole in the distal end;
a flange extending from the housing; and
an aperture in the flange for connecting the flange to a stationary component within the operating environment so the housing is maintained in position relative to the nut after being threaded over the bolt.

2) The apparatus of claim 1 wherein the housing is substantially cylindrical and sized so that an inner surface of the distal end abuts a top surface of the nut to create a double nut locking arrangement when the flange is proximate a surface to which the housing will be connected.

3) The apparatus of claim 2 wherein the flange is formed around at least a portion of the circumference of the proximal end and extends substantially perpendicularly from the housing.

4) The apparatus of claim 2, the housing and the flange comprising a heat resistant fiberglass material.

5) The apparatus of claim 1 further comprising:
an insert having an internally threaded aperture for threading the insert onto the threaded portion of the bolt, the insert sized to fit with the housing.

6) The apparatus of claim 1 further comprising:
a fastener for connecting the housing to at least one of the plurality of stationary components.

7) An apparatus for retaining a nut on a bolt, the apparatus comprising:
a housing defining an interior cavity having a constant cross section along its longitudinal axis, the housing sized to fit over and cover at least a portion of the nut so that the interior cavity is spaced away from the nut, the housing comprising an end cap;
a threaded aperture formed within the end cap for threading the housing onto a threaded portion of the bolt, the threaded aperture forming a through hole in the end cap;
a circumferential flange extending substantially perpendicularly from the housing, the housing sized so that the circumferential flange is disposed proximate a substrate to which the housing will be secured when the housing is threaded over the bolt; and
at least one aperture formed within the flange for securing the housing to the substrate.

8) The apparatus of claim 7, the housing and the circumferential flange comprising a heat resistant fiberglass material.

9) The apparatus of claim 7 further comprising:
an insert having an internally threaded aperture for threading the insert onto the threaded portion of the bolt, the insert sized to fit within the housing and create a double nut locking arrangement with the nut when the insert and the housing are threaded over the bolt.

10-20. (canceled)
